(19) United States
(12) Patent Application Publication
(10) Pub. No.: US 2024/0173593 A1
(43) Pub. Date: May 30, 2024

(54) SNOW BURIAL SURVIVAL MASK

(71) Applicant: Steven Brookes, Spring Valley, CA (US)

(72) Inventor: Steven Brookes, Spring Valley, CA (US)

(21) Appl. No.: 18/437,797

(22) Filed: Feb. 9, 2024

Related U.S. Application Data
(63) Continuation-in-part of application No. 17/086,040, filed on Oct. 30, 2020, now Pat. No. 11,918,834.

(51) Int. Cl. A63B 29/02; A62B 18/08; A62B 33/00

(52) U.S. Cl. CPC A63B 29/021; A62B 18/08; A62B 33/00

(57) ABSTRACT

A snow burial mask of the present disclosure comprises a burial sensor module, a processing unit, and a location tracker. The burial sensor module is configured to measure at least one indication of a snow burial. The location tracker is connected to an external device to receive a first location data and the processing unit. The processing unit is connected to the burial sensor module and configured to determine whether the snow burial has occurred based on measurements of the burial sensor module. The location tracker sends out the location data if the processing unit determines the snow burial has occurred.

### CROSS-REFERENCE TO RELATED APPLICATIONS

This application claims priority to, and is a continuation-in-part of, U.S. patent application Ser. No. 17/086,040, filed Oct. 30, 2020, now pending. Although incorporated by reference in its entirety, no arguments or disclaimers made in the parent application apply to this continuation-in-part application. Any disclaimer that may have occurred during the prosecution of the above-referenced application is hereby expressly rescinded.

### FIELD OF THE INVENTION

The present disclosure relates generally to safety equipment. More particularly, the present disclosure relates to a personal survival device in the event of accidental snow burial by avalanche or tree well encounter.

### BACKGROUND OF THE INVENTION

A winter sport or winter activity is a recreational activity or sport which is played on snow or ice. Most such sports are variations of skiing, ice skating and sledding. Traditionally such sports were only played in cold areas during winter, but artificial snow and artificial ice allow more flexibility. Artificial ice can be used to provide ice rinks for ice skating, ice hockey and bandy in a milder climate.

Common individual sports include cross-country skiing, Alpine skiing, snowboarding, ski jumping, speed skating, figure skating, luge, skeleton, bobsleigh and snowmobiling. Common team sports include ice hockey, curling and bandy. Winter sports often have their own multi-sport tournaments, such as the Winter Olympic Games.

In winter sports such as skiing, snowboarding, snowmobiling, snow hiking, showshoeing, or other activities involving traversing through snowy areas, often down mountains or hills, significant danger is posed to the participants by snow burial by avalanche or falling into a tree well. A tree well is a void of area or loose snow around the trunk of a tree enveloped in deep snow. The branches of the tree form a cover around the base of the trunk, thus preventing snow from accumulating around the trunk of the tree in a uniform manner to the surrounding environment and forming a void into which individuals may fall. Such wells have been observed as deep as 20 feet.

Falling into tree wells while skiing, snowboarding or otherwise traversing a snow-covered mountain slope is a main cause of fatalities in winter sports. Victims can get trapped in tree wells and become unable to free themselves. Frequently, victims end up in wells head first, complicating recovery efforts, and are often they are injured in the process, suffering joint dislocation or concussion. If an individual is unfortunate enough for this to happen while skiing alone, they may have a less than 10% chance of survival without safety and survival equipment suited to the purpose. In addition to dangers from cold exposure, dehydration and hunger from being physically trapped in the tree well, individuals may also find their head buried by snow. Following a snow burial incident, a buildup of carbon dioxide, not a shortage of oxygen, will often result in suffocation if the individual is not extracted within the first few minutes.

Therefore, it is an objective of the present disclosure to provide a piece of survival equipment, specifically a mask, which sends out rescue signals that includes the location of the mask to rescue personnel to locate and recue the mask wearer.

It is also an objective of the present disclosure to provide a piece of survival equipment, specifically a mask, which creates alarm signals for near rescue personnel to more precisely locate and recue the mask wearer.

The main advantage of the present disclosure is that user action is not strictly required for functionality. The user is automatically protected through and air pump activated by one or more sensors that can detect a burial condition.

### BRIEF DESCRIPTION OF THE DRAWINGS

FIG. 1 is an illustration of the present disclosure being worn by a user.

FIG. 2 is a close-up view of the present disclosure illustrating airflow being drawn into the intake port of the exhaust tube.

FIG. 3 is an illustration of the electronics package of the present disclosure.

FIG. 4 is an illustration of the exhaust tube venting air behind the user's back.

FIG. 5 is a block diagram of the electronic components according to a first embodiment of the present disclosure.

FIG. 6 is an illustration of the present disclosure with a mouthpiece.

FIG. 7 is a block diagram of the electronic components according to a second embodiment of the present disclosure.

FIG. 8 is a block diagram of the electronic components according to a third embodiment of the present disclosure.

FIG. 9 is a block diagram of the electronic components according to a fourth embodiment of the present disclosure.

### DETAILED DESCRIPTION OF THE INVENTION

All illustrations of the drawings are for the purpose of describing selected versions of the present disclosure and are not intended to limit the scope of the present disclosure. The present disclosure is to be described in detail and is provided in a manner that establishes a thorough understanding of the present disclosure. There may be aspects of the present disclosure that may be practiced or utilized without the implementation of some features as they are described. It should be understood that some details have not been described in detail in order to not unnecessarily obscure focus of the invention.

The present disclosure is an apparatus for use by skiers, snowboarders, snowmobilers, hikers, snowshoers, and any other activity involving avalanche or tree well exposure. The present disclosure extends survival time in the event of accidental snow burial by avalanche or tree well encounter.

Following a snow burial incident, a buildup of carbon dioxide (not a shortage of oxygen) will often result in suffocation if the individual is not extracted within the first few minutes. When triggered (by a reduction in light, movement, or other metrics) the present disclosure draws carbon dioxide (CO2) away from the user's airways and deposited it behind the users back, thereby extending survival time and greatly increasing the chances of successful extraction.

The present disclosure is a mask which can afford an individual a much greater chance of survival in case of being buried in snow due to an avalanche or falling into a tree well. In such cases, the buildup of carbon dioxide (CO2) gas can quickly be fatal. The present disclosure can detect a burial event and automatically trigger a pumping mechanism to move air from the user's immediate breathing area to another area, such as behind the user's back, thus removing CO2 buildup around the user's nose and mouth and extending survival time. The present disclosure may also be activated manually in some embodiments, by covering a light sensor in order to trigger the pump in order to remove exhaled air containing moisture in order to de-fog the user's goggles. Additionally or alternatively, the user may activate a switch to perform the same function. This functionality may only be available is the battery reserves of the present disclosure is over a specified threshold, such as 50% charge, in order to ensure adequate battery power to function in case of a burial event.

The advantages of the present disclosure over existing products include: the present disclosure activates automatically in the event of a snow burial; the present disclosure does not require the user to be conscious to be effective; the present disclosure is continuously ready to activate; the present disclosure may provide demisting of the user's goggles, increasing visibility and therefore safety; the present disclosure has mechanical and electrical components that facilitate automatic function in case of a snow burial.

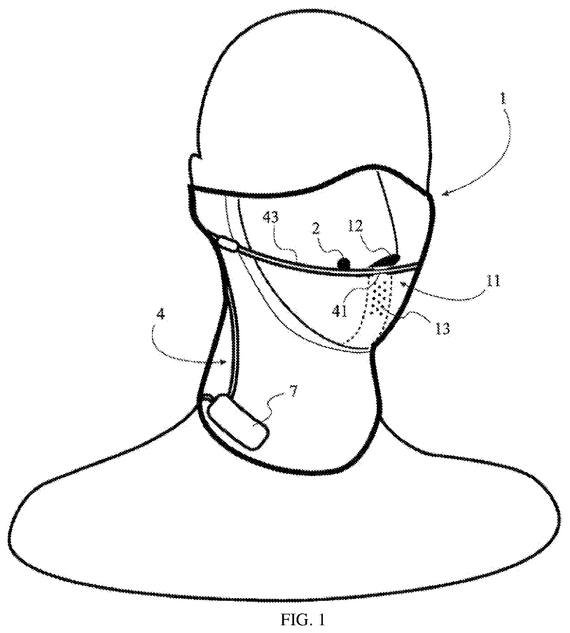

In general, referring to FIGS. 1-5, the present disclosure comprises a headgear 1, at least one burial sensor 2, a power source 3, an exhaust tube 4, and an air pump 5. In some embodiments, the headgear 1 is a face mask. In some embodiments, the headgear 1 may be a helmet, a wearable wire frame, an arrangement of straps, or any other head-wearable object that is able to facilitate the spirit of the present disclosure. The headgear 1 may be made of various fabrics, textiles, plastics, metals, or other materials, and may be manufactured according to any known or new manufacturing process.

The headgear 1 comprises a breathing portion 11, as shown in FIG. 1. The breathing portion 11 represents a location on the headgear 1 that will be located near a user's nose and/or mouth while the present disclosure is being worn. The exhaust tube 4 comprises an intake port 41 and an exhaust port 42. The intake port 41 of the exhaust tube 4 is connected to the headgear 1 adjacent to the breathing portion 11. The power source 3 is electrically connected to the at least one burial sensor 2 and the air pump 5, and the air pump 5 is operatively connected to the exhaust tube 4, such that the air pump 5 functions to pump air from the intake port 41 to the exhaust port 42. Preferably, the power source 3 comprises at least one battery 31. The power source 3 may be one or more rechargeable batteries, and the power source 3 may either be removable or non-removable in various embodiments.

In some embodiments, the breathing portion 11 comprises a nose portion 12 and a mouth portion 13, as known to exist on some types of headgear 1 such as cold weather face masks. In such a case, the intake port 41 of the exhaust tube 4 is positioned between the nose portion 12 and the mouth portion 13. It should be understood that the exhaust tube 4 may be affixed to the headgear 1 in any relevant manner, such as, but not limited to, being sewn or stitched into a fabric lining of the headgear 1, connected to an external or interior surface of the headgear 1 through fasteners such as clips, buckles, or snaps, or any other appropriate means.

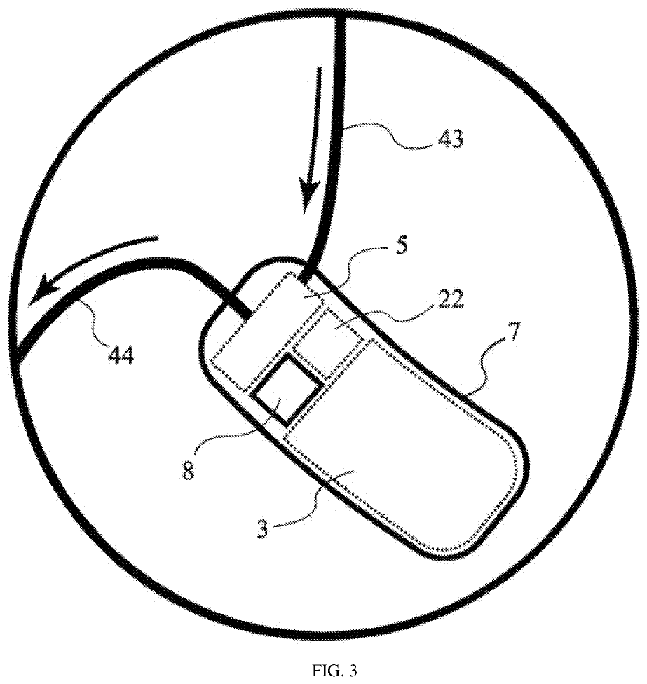

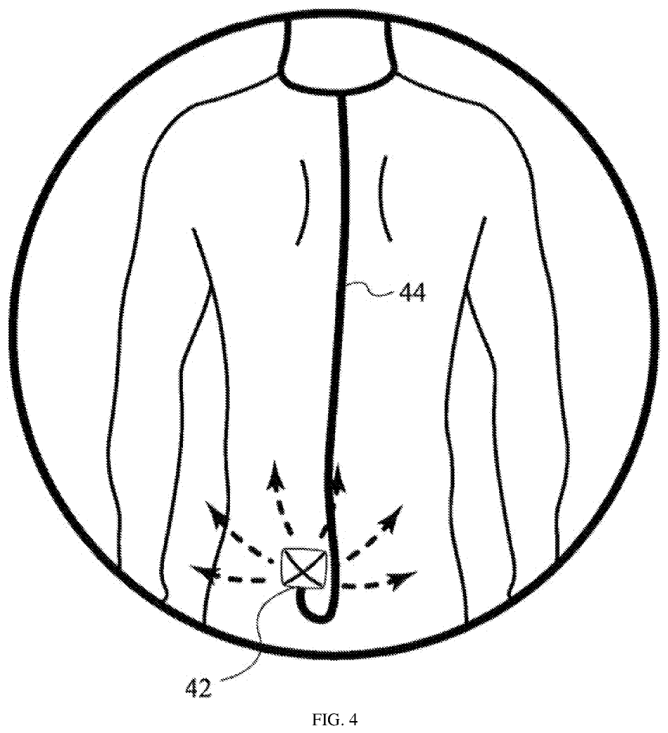

In the preferred embodiment, the exhaust tube 4 comprises an intake tube portion 43 and an exhaust tube portion 44, and the air pump 5 is operatively connected between the intake tube portion 43 and the exhaust tube portion 44, as illustrated in FIG. 3. The intake port 41 traverses into the intake tube portion 43 opposite the air pump 5, and the exhaust port 42 traverses into the exhaust tube portion 44 opposite the air pump 5. The intake tube portion 43 is connected to the headgear 1, preferably adjacent the breathing portion 11, and more particularly between the nose portion 12 and the mouth portion 13, though various embodiments of the present disclosure may place the intake tube portion 43 in other locations on the headgear 1. The exhaust port 42 of the exhaust tube portion 44 may be free to be manipulated into any desired position, though it is ideal to position the exhaust port 42 behind the back of the user for most efficient displacement of CO2, as shown in FIG. 4. Some embodiments may furthermore or alternatively comprise an attachment clip arrangement to which the exhaust port 42 is connected, allowing the user to affix the exhaust port 42 to the waistband of their pants or another location or item of clothing.

In some embodiments, the present disclosure may further comprise a harness worn on the torso of the user, to which the exhaust tube 4 is connected behind the back of the user. The intake tube portion 43 and the exhaust tube portion 44 are connected in fluid communication to the air pump 5 such that air is forced by the air pump 5 to travel from the intake port 41, through the intake tube portion 43, through the air pump 5, through the exhaust tube portion 44, and out the exhaust port 42.

It is contemplated that various different configurations of the exhaust tube 4 may be utilized in various embodiments of the present disclosure. For example, in one embodiment, a face portion of the intake tube portion 43 may wrap around the face of the user in a loop arrangement, with a connection portion being connected between the face portion and the air pump 5.

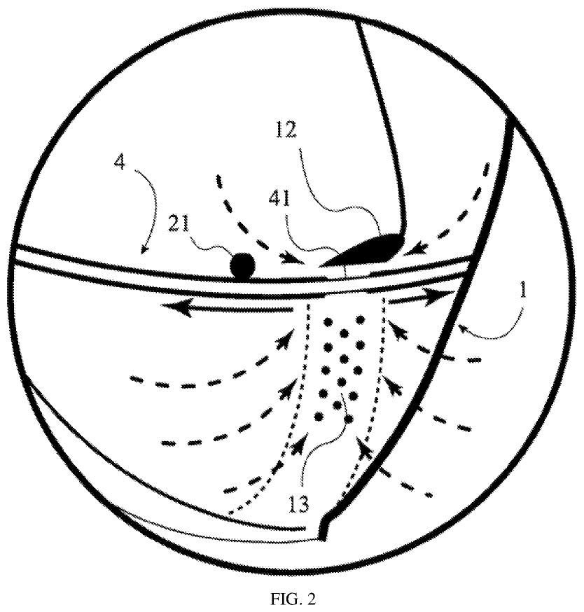

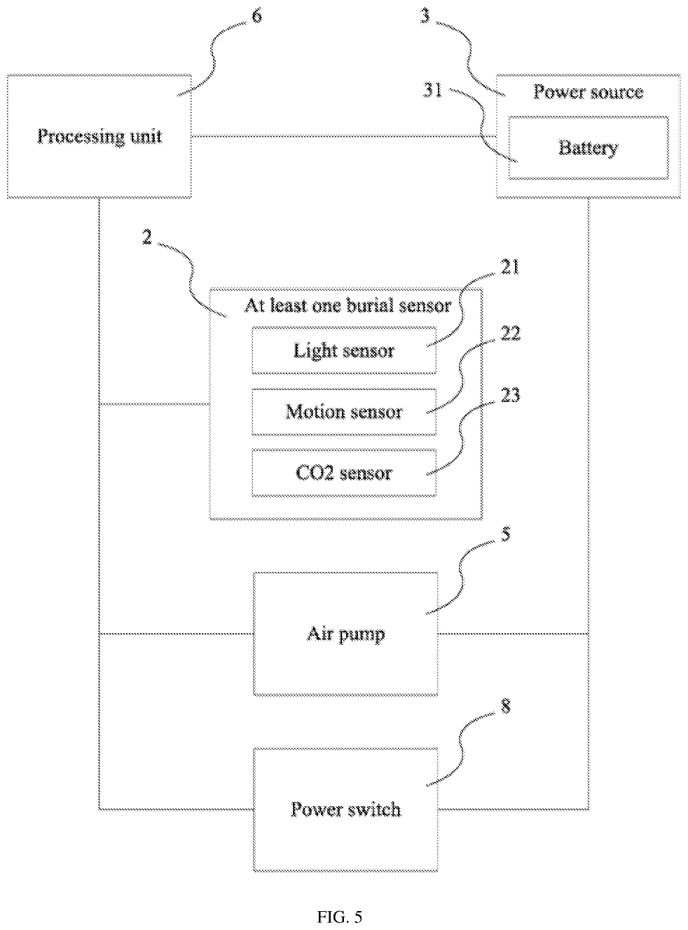

The at least one burial sensor 2 is important to the functionality of the present disclosure. Referring to FIG. 5, in various embodiments, it is contemplated that the at least one burial sensor 2 may be any type of sensor or combination of sensors which can detect various indications of snow burial. In some embodiments, the at least one burial sensor 2 comprises a light sensor 21 shown in FIG. 2. The light sensor 21 may be positioned adjacent to the breathing portion 11, or in other locations in other embodiments. The air pump 5 is triggered when the light sensor 21 detects a sudden decrease in light detected. In some embodiments, the at least one burial sensor 2 comprises a motion sensor 22. The air pump 5 may be triggered when the motion sensor 22 detects one or more of a variety of types of motion, such as, but not limited to, a sudden acceleration, a sudden drop, a lack of movement for a specific amount of time, or other conditions. In some embodiments, the at least burial sensor 2 may comprise both the light sensor 21 and the motion sensor 22, and both the light sensor 21 and the motion sensor 22 may be configured to activate the air pump 5 under a combination of signals from both sensors. In some embodiments, the at least one burial sensor 2 may comprise a CO2 sensor 23. In some embodiments, the at least one burial sensor 2 may comprise an infrared light sensor 21. It should be understood that the at least one burial sensor 2 may comprise other types of sensors not herein discussed, and furthermore may comprise any combination of sensors discussed and not discussed herein, and activation conditions for the air pump 5 may vary according to the type of sensors utilized, and activation conditions may depend on combinations of signals from various sensors. For example, the air pump 5 may only be activated if the CO2 sensor 23 detects increased CO2 levels from normal, the motion sensor 22 detects a stoppage in movement, and the light sensor 21 detects decreased light levels, all simultaneously or within a specified time period.

In some embodiments, the present disclosure further comprises a processing unit 6. The processing unit 6 may be a microprocessor, circuit board, integrated circuit, or any combination of electronic components such as, but not limited to, resistors, capacitors, transistors, diodes, and other electronic components that allows the present disclosure to receive electronic inputs, process data, and produce electronic outputs in order for the present disclosure to function as intended. The processing unit 6 is electronically connected to the at least one burial sensor 2 and the air pump 5, and the processing unit 6 is electrically connected to the power source 3.

In some embodiments, the present disclosure further comprises a housing 7, shown in FIG. 3. The housing 7 may be made of plastic, metal or any suitable material for housing 7 the various electronic components of the present disclosure, providing protection and structural integrity. Thus, in various embodiments, any or all of: the housing 7, at least one of the at least one burial sensor 2 (the motion sensor 22, the light sensor 21, and/or the CO2 sensor 23), the air pump 5, the power source 3, and the processing unit 6 may be positioned within the housing 7. Furthermore, the present disclosure may further comprise a power switch 8 externally connected to the housing 7.

The power switch 8 may be utilized to manually activate the air pump 5 of the present disclosure, or simply to turn on the present disclosure so as to be ready for use. In some embodiments, the power switch 8 is electrically connected directly between the power source 3 and the air pump 5. In some embodiments, the power switch 8 may be electrically connected to the processing unit 6, and/or at least one of the at least one burial sensor 2. Moreover, the present disclosure may further comprise additional controls, such as additional switches, buttons, touchscreens or any other controls that facilitate user control and operation of the present disclosure.

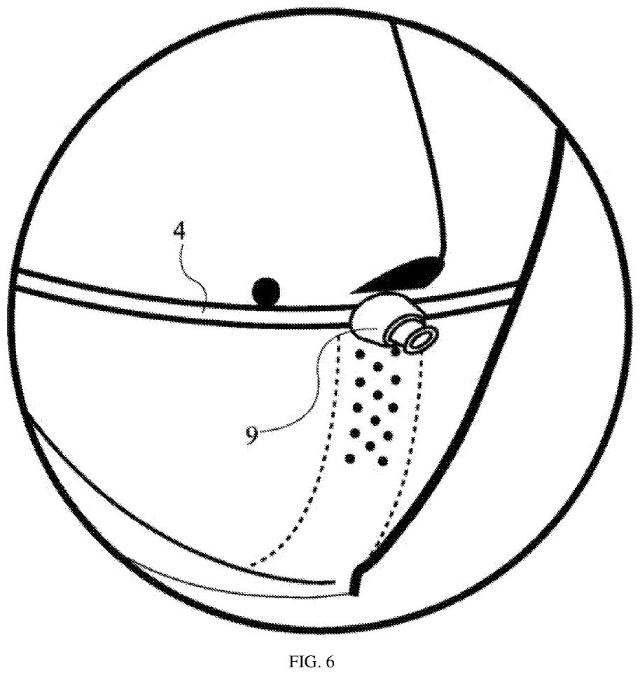

Referring to FIG. 6, in some embodiments, the present disclosure may further comprise a mouthpiece 9. The mouthpiece 9 may be connected to the exhaust tube 4 adjacent to the intake port 41, being in fluid communication with the exhaust tube 4. This is meant as a secondary measure in case the air pump 5 malfunctions, the user may exhale into the intake port 41 in order to manually pump CO2 away from the breathing area and out of the exhaust port 42. In some embodiments, the mouthpiece 9 is a one-way air valve.

In some embodiments, the mouthpiece 9 is a reversible nipple. Thus, the mouthpiece 9 protrudes away from the user's face in an inactive position when not in use. The mouthpiece 9 may be configured in such a way to be able to be inverted from the inactive position to an active position, then occupying equivalent space adjacent the user's face as previously occupied outside the mask. The user may achieve inversion of the mouthpiece 9 by pressing on the mouthpiece 9 from the outside of the mouth, resulting in inversion of the mouthpiece 9 and subsequent intrusion of the mouthpiece 9 interiorly to the mask and the user's mouth. The user may then bite on the mouthpiece 9 to keep the mask in place during an avalanche or other burial event, avoiding displacement of the mouthpiece 9 and ensuring CO2 displacement functionality. A one-way valve on the mouthpiece 9 similar to that of a dust mask allows the user to continue moving expelled air away from the face through the exhaust tube 4 even if the battery reserve of the power source 3 becomes exhausted, utilizing their own lungs to perform the pumping action.

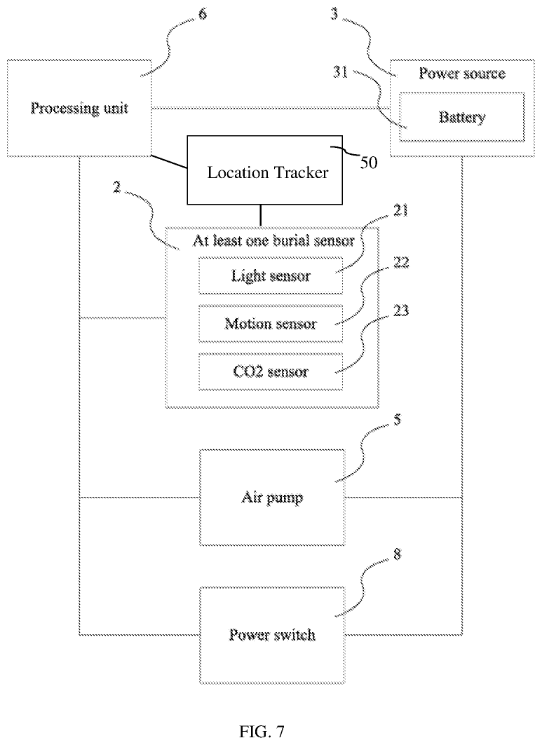

FIG. 7 is a block diagram of the electronic components according to another embodiment of the present disclosure. The snow burial mask includes a location tracker 50 having an antenna for connecting to a series of satellites using the antennas to determine location of the location tracker 50 and by extension that of the snow burial mask. The location tracker 50 uses a process called trilateration which uses the position of three or more satellites from the Global Navigation Satellite System (GNSS) network and its distance from them to determine latitude, longitude, elevation, and time. As illustrated in FIG. 7, the location tracker 50 is electrically connected to the processing unit 6.

The snow burial mask can detect a burial event and automatically sends out a rescue signal that includes the location of the snow burial mask and by extension that of the wearer. As discussed above, the location tracker 50 is connected to the processing unit 6 which is connected to the burial sensor 2 having the light sensor 21, the motion sensor 22, and the CO2 sensor 23. The processing unit 6 may determine that a snow burial event has occurred based on readings of the sensors 21, 22, 23 and then activate the location tracker 50 to send the location data to the rescue station using its antenna. Rescue personnel are then dispatched to the site where the location data was sent. In another embodiment, the location tracker 50 can be directly connected to the burial sensor 2, wherein the burial sensor 2 may be configured to directly activate the location tracker 50 to send out location signal using its antenna under a combination of signals from the sensors 21, 22, 23.

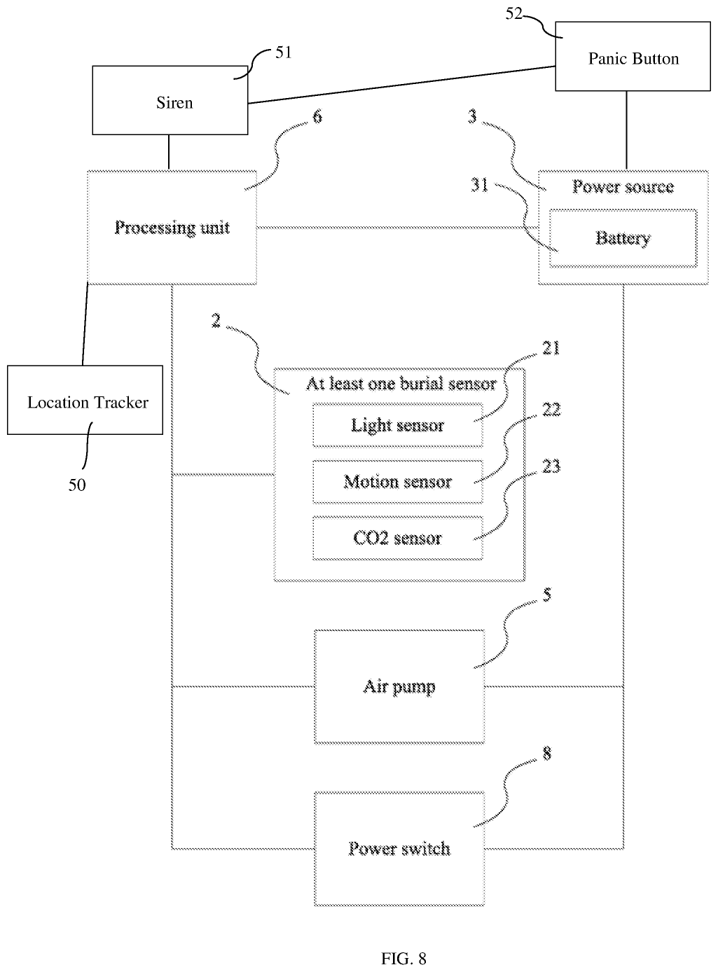

FIG. 8 is a block diagram of the electronic components according to yet another embodiment of the present disclosure. In the present embodiment, the snow burial mask further includes a siren 51 that can easily be activated to request help during an emergency where danger to persons or property exists. As illustrated in FIG. 8, the siren 51 is connected to the processing unit 6, wherein the processing unit 6 configures the siren 51 to create alarm signals if the processing unit determines the snow burial has occurred. Further, the location tracker 50 can communicates with a second external device on a rescue personnel to receive a second location data indicative of a location of the second external device and that of the rescue personnel. The processing unit 6 can calculates the distance between the location tracker and the second external device (rescue personnel) based on the first and second location data. The processing unit 6 can then configure the siren 51 to create alarm signals if the second external device is within a preset audible range, in order to help the rescue personnel to locate the snow burial mask and wearer buried under snow.

In addition, the snow burial mask can include a panic button 52 connected to the siren 51. When pressed, the panic button 52 sends a signal to the siren 51 to start generating alarm signals such as audible alarm sound and visible alarm light. The panic button 51 is powered by the power source 3, typically waterproof, and designed to be shock resistant and highly durable. In another embodiment, the snow burial mask is connected to an alarm monitoring station using the antenna. When the alarm is activated, the signal is transmitted to the alarm monitoring station using the antenna, other emergency agency or other programmed phone numbers. The processing unit can also be configured to keep track of the location of the location tracker and that of an electronic on rescue personnel dispatched to rescue the wearer of the snow burial mask. The processing unit can then monitor the distance between the location tracker and the rescue personal and then configure the siren to generate alarm signals (such as audible alarm sound and visible alarm light) to help the rescue personal to pinpoint the location of the snow burial mask.

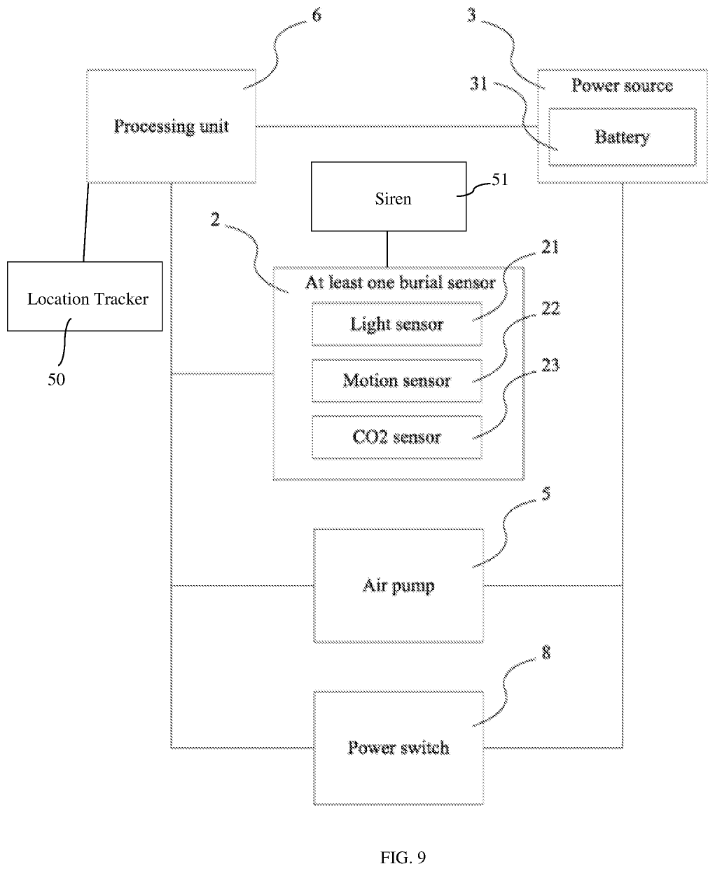

FIG. 9 is a block diagram of the electronic components according to yet another embodiment of the present disclosure. In the present embodiment, the siren 51 is connected to the burial sensor module 2 to process measurements from the burial sensor module 2. The siren 51 is configured to creates alarm signals if the measurement of the burial sensor 2 indicates that the snow burial has occurred, in order to allow nearby people not buried by snow to locate and rescue the wearer of the snow burial mask.

Although the invention has been explained in relation to its preferred embodiment, it is to be understood that many other possible modifications and variations can be made without departing from the spirit and scope of the invention as hereinafter claimed.

1. A snow burial mask comprising:
a burial sensor module configured to measure at least one indication of a snow burial;
a location tracker connected to a first external device to receive a first location data; and
a processing unit connected to the burial sensor module and the location tracker; wherein
the processing unit is configured to determine whether the snow burial has occurred based on measurements of the burial sensor module, the location tracker sends out the location data if the processing unit determines the snow burial has occurred.

2. The snow burial mask of claim 1, further comprising a siren connected to the processing unit, wherein the processing unit configures the siren to create alarm signals if the processing unit determines the snow burial has occurred.

3. The snow burial mask of claim 1, further comprising a siren connected to the processing unit, the location tracker communicates with a second external device to receive a second location data indicative of a location of the second external device, the processing unit calculates a distance between the location tracker and the second external device based on the first and second location data, the processing unit then configures the siren to create alarm signals if the distance is within an audible range.

4. The snow burial mask of claim 1, further comprising a siren connected to the burial sensor module, wherein the siren creates alarm signals if the measurement of the burial sensor indicates that the snow burial has occurred.

5. The snow burial mask of claim 1, further comprising:
a siren; and
a user interface operatively connected to the siren, wherein a user uses the user interface to configure the siren to create alarm signals.

6. A snow burial mask comprising:
a burial sensor module configured to measure at least one indication of a snow burial;
a location tracker connected to a first external device to receive a first location data and the burial sensor module; wherein
the location tracker sends out the location data if the measurement of the burial sensor indicates that the snow burial has occurred.

7. The snow burial mask of claim 6, further comprising a siren connected to the burial sensor module, wherein the siren creates alarm signals if the measurement of the burial sensor module indicates that the snow burial has occurred.

8. The snow burial mask of claim 6, further comprising a siren connected to the location tracker, the location tracker communicates with a second external device to receive a second location data indicative of a location of the second external device, the location tracker calculates a distance between the location tracker and the second external device based on the first and second location data, the location tracker then configures the siren to create alarm signals if the distance is within an audible range.

9. The snow burial mask of claim 6, further comprising:
a siren; and
a user interface operatively connected to the siren, wherein a user uses the user interface to control the siren to create alarm signals.

10. A method of seeking help using a snow burial mask while in a snow burial, comprising:
measuring at least one indication of a snow burial;
obtaining a first location data indicative of a location of the snow burial mask; and
the first location data if the measurement of the burial sensor module indicates the snow burial has occurred.

11. The method of seeing help of claim 10, further comprising:
providing the snow burial mask having:
a burial sensor module configured to measure at least one indication of the snow burial; and
a location tracker connected to a first external device to receive the first location data, wherein the first location data corresponds to the location of the location tracker; and
configuring the location tracker to send out the first location data of the location tracker if the measurement of the burial sensor module indicates the snow burial has occurred.

12. The method of seeing help of claim 11, further comprising:
connecting a processing unit to the burial sensor module to receive the measurement;
connecting the processing unit to the location tracker;
configuring the processing unit to determine whether the snow burial has occurred based on measurements of the burial sensor module; and
configuring the processing unit to configure the location tracker to send out the location data of the location tracker if the processing unit determines that the snow burial has occurred.

13. The method of seeing help of claim 11, wherein the snow burial mask includes a siren and a processing unit, the method further comprises:
connecting the processing unit to the siren and the location tracker;
configuring the location tracker to communicate with a second external device to receive a second location data indicative of a location of the second external device;
configuring the processing unit to calculate a distance between the location tracker and the second external device based on the first and second location data; and
configuring the processing unit to control the siren to create alarm signals if the distance is within an audible range.

14. The method of seeing help of claim 11, wherein the snow burial mask includes a siren, the method further comprises:
configuring the siren to create alarm signals if the measurement of the burial sensor module indicates that the snow burial has occurred.

15. The method of seeing help of claim 11, wherein the snow burial mask includes a siren and a user interface operatively connected to the siren, the method further comprises:
configuring the siren and the user interface to allow a user uses the user interface to control the siren to create alarm signals.
